(19) United States
(12) Patent Application Publication
(10) Pub. No.: US 2020/0050171 A1
(43) Pub. Date: Feb. 13, 2020

(54) METHOD OF QUANTITATIVELY EVALUATING MACHINED SURFACE QUALITY

(71) Applicant: OKUMA CORPORATION, Niwa-gun (JP)

(72) Inventor: Arisa Seki, Niwa-gun (JP)

(21) Appl. No.: 16/536,420

(22) Filed: Aug. 9, 2019

(30) Foreign Application Priority Data
Aug. 13, 2018 (JP) 2018-152386

(51) Int. Cl. G05B 19/402; B23D 5/00; G06F 17/14

(52) U.S. Cl. CPC G05B 19/402; G05B 2219/37582; G06F 17/142; B23D 5/00

(57) ABSTRACT

Provided is a method of quantitatively evaluating machined surface quality, in which quantitatively evaluating the machined surface quality is possible and a stable evaluation is obtained. The method includes the steps of: measuring the positions of cutter marks arranged in a feed direction of machining paths; calculating a difference between the positions of the cutter marks on the adjacent machining paths in a pickfeed direction; and quantitatively evaluating the surface quality using a standard deviation of the difference.

### TECHNICAL FIELD

The present invention relates to a method of quantitatively evaluating quality of a surface that is machined, and more particularly to a method of quantitatively evaluating machined surface quality using cutter marks.

### BACKGROUND ART

For example, the external appearance of a product to be pressed depends on surface roughness of a press die to be used, and therefore a polishing process is extremely important in manufacturing the die. However, a lot of time and cost to be spent for the polishing process has conventionally been a problem. Moreover, in recent years, for example, a press die for an outer part of an automobile body is required to create a character line that spotlights the contrast between light and shade, and even how the character line disappears becomes an issue to address for the press die. Thus, a situation in which the polishing process unintentionally causes deterioration in shape accuracy and in design of the die that has been machined has becomes a new problem to be solved. Under such circumstances, in order to reduce or eliminate the polishing process, providing a high-quality surface is required in machining a large-scale press die.

It should be noted that, Patent Literature 1 describes a cutter mark, which is to be used in the present invention, as a mark produced on the machined surface of a workpiece in a case where the curved surface is machined using an end mill, and also describes an endeavor to control the machining with an aim to eliminate the cutter mark.

### CITATION LIST

### Patent Literature

Patent Literature 1: Japanese Unexamined Patent Application Publication JP-A-2011-39582

### SUMMARY OF INVENTION

### Technical Problem

With respect to machined surface quality, not only a control method but also a method of evaluating the surface quality matters. That is, although it is possible to evaluate surface roughness and shape accuracy using measuring instruments for the roughness or the shape, the final judgement is made through visual inspection, i.e., by an inspector's personal opinion. This is because an “appearance” cannot be evaluated quantitatively. Moreover, a decrease in the number of skilled person who have the ability to make judgements of the machined surface quality, and difficulty in passing the judgement skills down to trainees have become problems.

An object of the present invention is to provide a method of quantitatively evaluating machined surface quality, in which quantitatively evaluating the machined surface quality is possible and a stable evaluation is obtained.

### Solution to Problem

The method of quantitatively evaluating the machined surface quality in accordance with the present invention is a method in which the quality of a surface that has been machined using a machine tool is quantitatively evaluated using cutter marks. The method includes the steps of: measuring a position of each of the cutter marks arranged in a feed direction of a machining path; calculating a difference between the positions of the cutter marks on the machining paths that are adjacent to each other in a pickfeed direction; and evaluating the surface quality using a standard deviation of the difference.

When machining is performed using a machine tool, cutter marks are generated. Each of the cutter marks consists of: a central portion in which an amount of machining is relatively great; and a peripheral edge portion in which an amount of machining is relatively small, and the cutter marks are arranged in a feed direction and a pickfeed direction of the machining paths. By using the cutter marks and calculating the difference between the positions of the cutter marks on the machining paths that are adjacent to each other in the pickfeed direction using the standard deviation, it is determined that the smaller the variation in the positional difference is, the better the surface quality is. Thus, regarding the quantitative evaluation of the machined surface quality, which has been conventionally difficult, it becomes possible to perform a stable evaluation.

Positional measurement may be performed, for example, by using one point at an appropriate position of a cutter mark on the machining path. Alternatively, the mean value of the deviations with respect to a plurality of points may be calculated for the positional measurement. Still further alternatively, the deviation may be calculated from the mean value of the phase difference in a predetermined range.

It is preferable to calculate the difference between the positions of the cutter marks on the machining paths using a fast Fourier transform.

When cross-sectional data of the machining paths is transformed using a fast Fourier transform per machining path, each phase of the edge height (amplitude) of cutter marks that are adjacent to each other in a feed direction is obtained. By assuming that the phase difference of the cutter marks of the adjacent paths is a difference in the position, the method of quantitatively evaluating the machined surface quality may be conducted without requiring any special software.

### Advantageous Effects of Invention

With the method of quantitatively evaluating the machined surface quality in accordance with the present invention, regarding the quantitative evaluation of the machined surface quality, which has been conventionally difficult, it becomes possible to perform a stable evaluation.

### BRIEF DESCRIPTION OF DRAWINGS

FIG. 1 shows steps of a method of quantitatively evaluating machined surface quality in accordance with the present invention.

FIG. 2 shows a machined surface and machining paths to which the method of quantitatively evaluating the machined surface quality in accordance with the present invention is applied.

FIG. 3 is a diagram showing a phase difference (a position deviation amount) of the cutter marks.

FIG. 4A and FIG. 4B show examples of a high quality surface.

FIG. 5 shows an example of a low quality surface.

### DESCRIPTION OF EMBODIMENTS

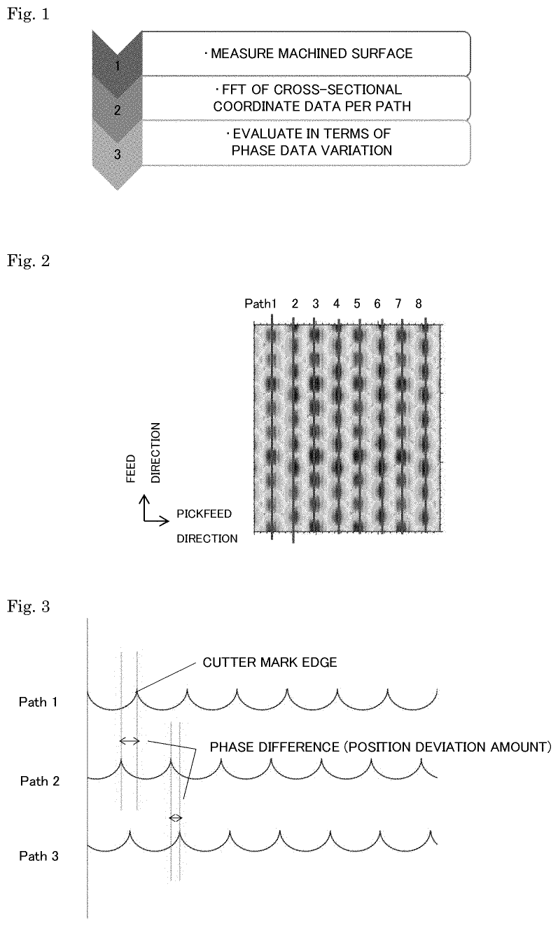

A method of quantitatively evaluating machined surface quality in accordance with an embodiment of the present invention will be described below with reference to FIG. 1 to FIG. 5.

The method of quantitatively evaluating the machined surface quality in accordance with the present invention enables the evaluation of the surface quality, which has been conventionally performed through visual inspection and the like, to be performed in a quantitative manner. As shown in FIG. 1, the method is characterized by: measuring the machined surface (step 1); analyzing cross-sectional coordinate data per machining path, using a fast Fourier transform (FFT) (step 2); and evaluating the surface quality using variations of phase data (step 3).

As shown in FIG. 2, in a case where machining is performed using a machine tool, cutter marks are arranged in a feed direction and in a pickfeed direction, with each cutter mark consisting of: a portion where an amount of machining is relatively great (dark-colored portion); and a surrounding portion where an amount of machining is relatively small (light-colored portion).

In the case where there are no variations, the cutter marks are supposed to be arranged with regularity (for example, cutter marks having an identical shape are arranged at an equal pitch both in the feed direction and in the pickfeed direction). However, when the machining is actually performed, a phase difference (a position deviation amount) between the adjacent machining paths, as shown in FIG. 3, for example.

The method of quantitatively evaluating the machined surface quality in accordance with the present invention uses the positions of the cutter marks for evaluation. In step 1, in each machining path on the machined surface, a cross-sectional curved line is measured at a center position of each of the cutter marks arranged in the feed direction.

In step 2, after the measurement, a fast Fourier transform (hereinafter referred to as FFT) of the cross-sectional data of each machining path is performed to focus on phase data. Performing an FFT per machining path (see FIG. 2) produces the edge height for each of the adjacent cutter marks in the feed direction, as amplitude. This phase represents the position of the edge height of each cutter mark, i.e., a cutter mark arrangement.

In step 3, in order to obtain the phase difference (the position deviation amount) with respect to the position of the cutter mark (see FIG. 3), the phase difference of the cutter marks on adjacent paths is calculated, and the surface quality is evaluated using a standard deviation. The standard deviation is calculated using the following mathematical equation 1. The smaller the value of the standard deviation is, the less the variation is. That is, the small value indicates that the cutter mark arrangement has uniformity, and therefore the surface quality is high.

$$S = \sqrt{\frac{1}{n - 1} {\sum }_{n = 1}^{n - 1} {( \vert Xa + 1 - Xa \vert - Xave )}^{2}} \qquad [ Mathematical equation 1 ]$$

S: standard deviation
n: number of paths
Xa: phase of aₜₕ path (°)
Xa+1: phase of a+1ₜₕ path (°)
Xave: mean value of phase difference

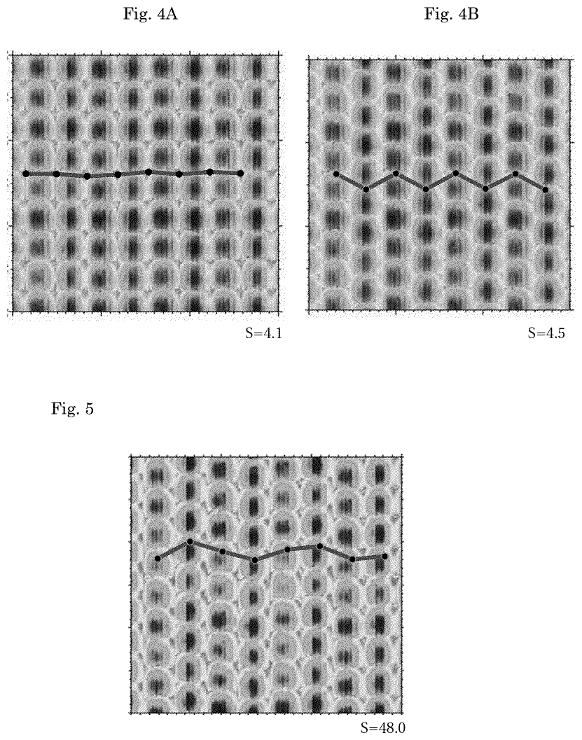

FIG. 4 shows examples of a high quality surface, whereas FIG. 5 shows an example of a low quality surface. In FIG. 4 and FIG. 5, an amount of machining, which may be shown in color as a continuation amount, is shown as a grayscale image.

For example, as shown on the left side of FIG. 4, in the case where adjacent cutter marks have little deviation in the vertical direction in terms of the drawing sheet, the variation value is 4.1. In this case, the following determination: a small variation=uniformity confirmed=high quality surface, is applied.

In addition, for example, as shown on the right side of FIG. 4, in the case where, although adjacent cutter marks respectively have a substantial deviation in the vertical direction in terms of the drawing sheet, they have regularity with few differences among odd-number path lines and among even-number path lines, the variation value is 4.5. In this case, the following determination: a small variation=uniformity confirmed=high quality surface, is also applied.

On the other hand, as shown in FIG. 5, in the case where adjacent cutter marks have a great deviation in the vertical direction in terms of the drawing sheet and they have no regularity, the variation value is 48.0. In this case, the following determination: a great variation=ununiformity confirmed=low quality surface, is applied.

As described above, by plotting the cutter mark arrangement as a phase using an FFT, the machined surface quality may be evaluated quantitatively.

It should be noted that the measurement of the positions is not limited to the points indicated by black circles in the drawings. The points to be measured may be one point per one cutter mark. Alternatively, the mean value of the deviations with respect to a plurality of points may be calculated. Still further alternatively, the deviation may be calculated from the mean value of the phase difference in a predetermined range. In other words, using the cutter marks is the key to determining the phase difference.

1. A method of quantitatively evaluating machined surface quality, in which the quality of a surface that has been machined using a machine tool is quantitatively evaluated using cutter marks, the method comprising the steps of:
measuring a position of each of the cutter marks arranged in a feed direction of a machining path;
calculating a difference between the positions of the cutter marks on the machining paths that are adjacent to each other in a pickfeed direction; and
evaluating the surface quality using a standard deviation of the difference.

2. The method of quantitatively evaluating the machined surface quality according to claim 1, wherein the position of the cutter mark on each of the machining paths is calculated using a fast Fourier transform.

3. The method of quantitatively evaluating the machined surface quality according to claim 1, wherein
the equation to calculate the standard deviation S is
$$S = \sqrt{\frac{1}{n - 1} {\sum }_{n = 1}^{n - 1} {( \vert Xa + 1 - Xa \vert - Xave )}^{2}}$$
n: number of paths
Xa: phase of aₜₕ path (°)
Xa+1: phase of a+1ₜₕ path (°)
Xave: mean value of phase difference
and when S is equal to or less than a predetermined value, the machined surface quality is determined better and when S is equal to or larger than a predetermined value, the machined surface quality is determined worse.
